(19) United States
(12) Patent Application Publication
(10) Pub. No.: US 2003/0183998 A1
(43) Pub. Date: Oct. 2, 2003

(54) Machining apparatus

(76) Inventor: Masashi Osanai, Kanagawa-ken (JP)

Correspondence Address: BELL, BOYD & LLOYD, LLC, PO BOX 1135, CHICAGO, IL, 60690-1135, US

(21) Appl. No.: 10/375,797

(22) Filed: Feb. 27, 2003

(30) Foreign Application Priority Data
Mar. 8, 2002 (JP) 2002-063642

(51) Int. Cl. B23Q 1/00

(52) U.S. Cl. 269/46

(57) ABSTRACT

A machining apparatus in which vibration-isolating effect for devices therein is exhibited and which is made compact as a whole by effectively using space in the machining apparatus.

A device-supporting member for integrally fixing and supporting devices, such as a machining device and a workpiece-holding device, and hanging means for hanging down the device-supporting member in a machining space are disposed in the machining space of a machining apparatus body. Horizontal vibration is suppressed by using high vibration attenuation characteristics of the hanging means. Also, such devices as the machining device and the workpiece-holding device are integrally fixed to and supported by the device-supporting member, so that rigidity of the device-supporting member is enhanced and vertical vibration is reduced.

### BACKGROUND OF THE INVENTION

1. Field of the Invention

The present invention relates to a machining apparatus for carrying out micro-fabrication, and more particularly, to a machining apparatus having a structure for isolating vibration with respect to devices in the apparatus.

2. Description of the Prior Art

Conventionally, in production steps of, for example, semiconductor wafers, various kinds of micro-fabrication with a laser beam such as scribing, trimming and laser anneal are carried out. Also, in the production steps of the semiconductor wafers, it is necessary to set various and strict producing conditions in each step. In order to manage these conditions, primary marks such as numbers, characters and dots, or marks consisting of bar codes or the like are provided with predetermined depths on partial surfaces of the semiconductor wafers.

Meanwhile, marking with dots with uneven shapes is usually carried out by allowing a pulse laser beam to scan a partial surface of a semiconductor wafer through an optical system. This marking is carried out not only once, and in order to know historical characteristics of each production step, various kinds of historical information, such as essential processing histories in production steps of waters and semiconductors and historical characteristics for each lot, are indicated by means of a dot mark on a surface of an orientation flat portion of a wafer or a back surface of the wafer.

In addition, in recent years, as the applicant proposed previously in Japanese Patent Application Laid-open No. 2000-223382, it became possible to form a fine dot mark pattern which has a height of 0.01 to 5 μn and a maximum width of 1 to 15 μm, and which is excellent in visibility. Thus, marking areas became enlarged to a great extent. Consequently, it became possible to conduct marking on extremely fine areas, such as a scribe line, which is a cutting line for cutting a semiconductor wafer into chips with certain dimensions, a chamfer portion of a rim of a wafer, and a flat surface of a chamfer portion of a V-notch, which is a reference mark for positioning formed on a rim of a wafer.

Upon marking, a marking area of the wafer is positioned and supported at a set position of a laser marker in a state that the marking area is directed upward. The dot mark on the semiconductor wafer on which dot marking is carried out with a dot marker are read by scanning only one surface of the semiconductor wafer with a laser beam for reading marks. Various production conditions in subsequent production steps are set on the basis of the information read.

By the way, a chamfer area of the wafer rim or the V-notch portion to be dot-marked is extremely fine with a size of about 100 μm in a radial direction of the wafer, and it is inclined at a necessary angle with respect to the surface of the wafer. When such a fine area is dot-marked, it is necessary to precisely detect a flat portion of the chamfer area and to precisely position, with respect to the flat portion, an irradiation optical axis of a laser beam machining apparatus having a machining processing unit such as a laser oscillator and an optical system.

However, devices in the machining processing unit resonate by vibration transmitted from a floor to the machining processing unit of the laser beam machining apparatus when an operator walks around the apparatus, or vibration from an operation panel generated by operation force of the operator. Accordingly, in the production steps of the semiconductor wafers, positional displacement is generated in each device, and its set position is prone to change when fine dots are marked on the above-described extremely fine marking areas.

Upon formation of the dot mark by the laser beam of the laser beam machining apparatus, if external impact or vibration is applied to the devices and precision of set positions of the devices is varied, an error occurs in position or dimension of a dot pattern with respect to the surface of the wafer for example. Accordingly, a dot-mark shape is deteriorated. As a result, the dot mark inscribed on the wafer surface become unclear, and it becomes impossible to read the dot mark by a reading apparatus.

As described above, upon providing the fine dot mark on the extremely minute marking area, an error occurs in position or dimension of the dot pattern even if extremely small external force is applied to the devices. Therefore, it becomes difficult to obtain necessary machining precision. Consequently, visibility of the dot marks formed by inscription to the semiconductor wafer surface is deteriorated. Such problems are not limited to dot marking as described above: Positional deviation occurs for other fine electronic components or mechanical components which are to be marked by photolithography, etching or inscription even if very little external force or vibration is applied. Therefore, it becomes impossible to carry out fine machining with high machining precision.

There exists a well-known elastically supporting structure for bringing a vibration-isolating elastic body, such as a general rubber vibration isolator, in direct contact with a lower portion of the laser beam machining apparatus, thereby elastically supporting the vibration-isolating elastic body. However, this kind of elastically supporting structure is for absorbing and eliminating relatively great external force and vibration. Therefore, this structure cannot sufficiently exhibit its performance for absorbing small vibration or the like transmitted from outside with respect to the laser beam machining apparatus when the structure is used for fine machining such as applying the minute dot mark on the minute area like the flat surface of the wafer as described above. Therefore, even if the above-described elastically supporting structure is used, a dot-mark-forming position is prone to be deviated by vibration or the like from outside, and writing and reading operations of the dot mark are interfered. Accordingly, this structure is not suitable as a vibration absorbing structure in the machining apparatus which is required to have fine and accurate machining precision.

As another example of the vibration absorbing structure, there exists a general vibration-isolating apparatus into which an air spring, a position detector, an air adjusting device and the like are incorporated. Although this vibration-isolating apparatus exhibits great vibration-isolating performance, it has a large number of parts and a complicated structure. Therefore, flexibility in design for incorporating this vibration-isolating apparatus into the laser beam machining apparatus is low, and this is not practical.

Further, a footprint of the apparatus is focused on in a semiconductor producing facility and thus, the apparatus is often placed on a high position. Therefore, a barycenter position of each device disposed in the laser beam machining apparatus becomes high, vibration or the like from outside is easily received, and probability that the device cannot be operated normally due to the vibration or the like becomes high.

Meanwhile, there is conventionally proposed a vibration-isolating apparatus in a laser/punch compound machine in which a laser beam machining apparatus and a punch press machine are combined. This apparatus is for absorbing and eliminating impact force generated upon punching operation. Such an apparatus is proposed in Japanese Patent Application Laid-open No. 11-33793, for example. In the vibration-isolating apparatus of the laser beam machining apparatus disclosed in this publication, when operation is switched from laser machining to punching operation, an upper surface of a slider portion, in which a laser head in a frame of the punch press machine is hung and fixed, is brought into contact with a lower surface of the rubber vibration isolator so that the vibration isolator is supported.

The conventional vibration-isolating apparatuses including the one disclosed in said Japanese Patent Application Laid-open No. 11-33793 are not based on the assumption that these are used for the apparatus which carries out precise machining operation on the extremely minute area. Therefore, these apparatuses do not have structures capable of controlling subtle vibration. Accordingly, when the vibration-isolating apparatuses described above are applied to the machining apparatus which is required to have fine and accurate machining precision, the performance of the machining apparatus cannot be exhibited sufficiently, and moreover, the vibration-isolating performance with respect to the machining apparatus cannot be secured.

### SUMMARY OF THE INVENTION

The present invention has been accomplished to solve the conventional problems mentioned above. Specifically, its object is to provide an entirely compact machining apparatus capable of exhibiting its vibration-isolating effects for devices in the machining apparatus by rationally utilizing space in the machining apparatus.

According to this invention, there is provide a machining apparatus comprising a device-supporting member, which is disposed in a machining space of a machining apparatus body and which is for integrally fixing and supporting devices such as a machining device and a workpiece-holding device, and hanging means for hanging down the device-supporting member in the machining space.

According to a basic machining apparatus of the present invention, a simple structure in which devices such as the machining device and the workpiece-holding device are integrally fixed and supported is employed. In addition, the device-supporting member can be hung down and set in the machining space of the machining apparatus body by using the hanging means.

According to this invention, horizontal vibration is suppressed by utilizing high vibration attenuation performance of the hanging means. Also, such devices as the machining device and the workpiece-holding device are integrally fixed to and supported by the device-supporting member, so that rigidity of the device-supporting member is enhanced and vertical vibration is reduced.

Members, such as a rod, a rope spring and a chain, which have vibration absorption ability can be used as the hanging means. As materials of the hanging means and the device-supporting member, various materials, such as vibration-isolating alloy and vibration-isolating steel, which have great ability to absorb vibration energy can be used.

According to the hanging means, a space around the device-supporting member is used effectively without disposing a vibration-isolating stage using an air spring or the like below the machining apparatus body as in the conventional technique, and flexibility in design of the device-supporting member is enhanced. Moreover, structures of the device-supporting member and the hanging means can be simplified and the device-supporting member and the hanging means can be assembled in the limited and narrow space in the machining apparatus body. Consequently, the entire machining apparatus can be made compact.

Further, the hanging means has a vibration-absorbing member.

The vibration-absorbing member is interposed in an intermediate portion or the like of a hanging tool of the hanging means, so that vertical vibration attenuation effect is enhanced. Vibration having relatively high frequency component among frequency components generated by vertical vibration can be absorbed sufficiently. Inexpensive vibration-isolating means can be obtained because the hanging means of a simple structure having vibration-isolating ability can be easily produced. It is effective to appropriately select material, thickness, size, shape, position, disposed number and the like of the vibration-absorbing member in order to exhibit the vibration-isolating effect of the hanging means to a great extent. Various elastic materials such as rubber and resin having great vibration absorption ability can be used as the vibration-absorbing member.

Still further, the device-supporting member extends in a vertical direction of the machining space, and said various devices are disposed in the device-supporting member in its vertical direction.

According to this invention, a plurality of devices such as the machining device and the workpiece-holding device are arranged in parallel in the vertical direction in the device-supporting member comprising, for example, an L-shaped member extending in the vertical direction of the machining space. With this structure, the device-supporting member whose vertical rigidity is enhanced can be obtained effectively.

By disposing all of said devices on the vertically long L-shaped member, the simple structure is obtained where the hanging means is disposed on a side portion of the device-supporting member. Accordingly, rigidity with respect to the device-supporting member can be secured sufficiently, and proper vibration-isolating function can be exhibited with respect to relatively low frequency component among frequency components generated by vertical vibration. As the device-supporting member, it is possible to employ various shapes such as a reversed T-shape instead of the L-shape.

Preferably, the machining apparatus further comprises position-fixing means for positioning and fixing the device-supporting member in the machining apparatus body.

According to this invention, a position fixing cylinder, a bolt and the like can be used as the position-fixing means. The device-supporting member, to which such devices as the machining device and the workpiece-holding device are integrally fixed and supported, can be mechanically fixed to the machining apparatus body by a simple position-fixing operation in which a rod end of the position fixing cylinder is inserted and fixed into an inserted portion of a mating engaging member, or in which a bolt for fastening and fixing is used.

In this invention, the device-supporting member is hung down from and supported by the hanging means. Thus, when the workpiece is placed and set on the workpiece-holding device by the handling apparatus, or when the machining apparatus is transferred, the device-supporting member can be positioned and fixed to a proper position with simple operation of the position-fixing means. Consequently, it becomes possible to precisely and securely set the workpiece to the workpiece-holding device. Further, casual damages or defects of said devices can be avoided upon transferring the machining apparatus.

Still preferably, the machining apparatus comprises a cover body for surrounding a peripheral portion of the hanging means.

When the workpiece is to be finely machined, e.g., when a semiconductor wafer is to be processed, slight adherence of slight dust or a defect may cause great damage in semiconductor production. Therefore, close attention is paid to dust contamination not only in the machining space but also during transfer of the wafer in each machining step. According to this invention, dust, fine particle and the like which are generated by contact between the hanging means and an inner wall surface of the machining apparatus body, for example, can be discharged outward through an inner lower portion of the cover body without passing through the machining space. Accordingly, an interior of the machining space can be kept clean.

Furthermore, the machining apparatus is a laser beam machining apparatus.

Various functions described above can be effectively achieved by applying the laser beam to the laser beam machining apparatus which carries out micro-fabrication such as scribing, trimming, marking and laser anneal with the laser beam. Accordingly, it becomes possible to sufficiently absorb vibration transmitted to the devices of the machining processing unit in the machining space, and extremely fine optical machining can be carried out precisely.

### BRIEF DESCRIPTION OF THE DRAWINGS

FIG. 1 is a schematic front view showing an exterior of a semiconductor producing apparatus having a laser beam machining apparatus according to a representative embodiment of the present invention.

FIG. 2 is a side view of the same semiconductor producing apparatus.

FIG. 3 is a schematic enlarged view of a portion of the apparatus taken along the II-II line in FIG. 2.

FIG. 4 is a schematic perspective view of an example of arrangement of a device-supporting member and devices of the laser beam machining apparatus applied to the semiconductor producing apparatus.

FIG. 5 is a schematic enlarged view of a portion of the apparatus viewed from the arrow III in FIG. 2.

FIG. 6 is a schematic perspective view of an example of hanging means applied to the laser beam machining apparatus.

FIG. 7 is a schematic enlarged view of a portion of the apparatus taken along the IV-IV line in FIG. 5.

FIG. 8 is a schematic enlarged view of major portions showing an example of position-fixing means applied to the device-supporting member.

FIG. 9 is a schematic enlarged view of major portions showing an example of the position-fixing means applied to the hanging means.

FIG. 10 is a schematic enlarged view of a portion of the apparatus taken along the V-V line in FIG. 5.

FIG. 11 is a schematic explanatory view showing another embodiment of the hanging member.

FIG. 12 is a schematic explanatory view showing still another embodiment of the hanging member.

### DESCRIPTION OF THE PREFERRED EMBODIMENTS

Hereinafter, preferred embodiments of the present invention will be described in detail with reference to the accompanying drawings.

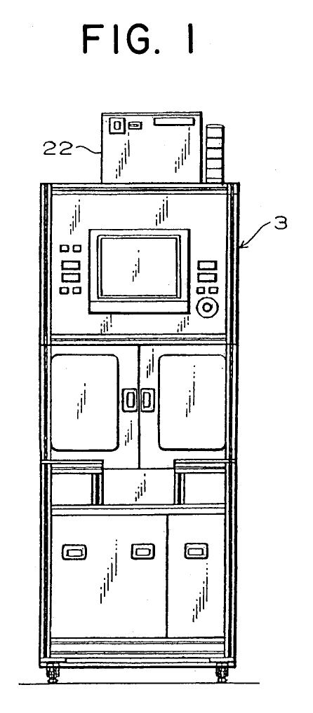

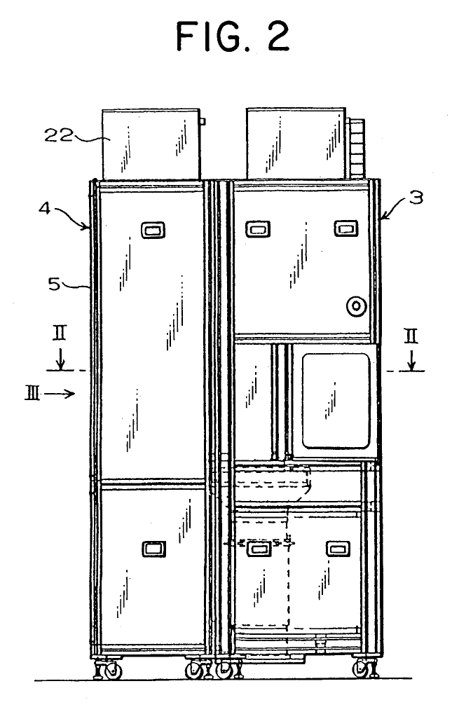

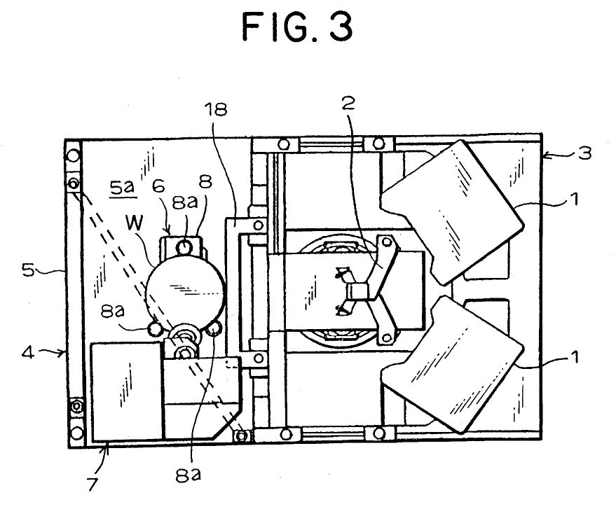

FIG. 1 is a schematic front view showing an exterior of a semiconductor producing apparatus having a laser beam machining apparatus according to a representative embodiment of the present invention. Whereas, FIG. 2 is a side view of the same semiconductor producing apparatus, and FIG. 3 is a schematic enlarged view of a portion of the apparatus taken along the II-II line in FIG. 2. This embodiment is explained with the laser beam machining apparatus which carries out fine machining on a semiconductor apparatus using laser beam. Yet, the invention is not limited to this and can be applied to various kinds of micro-fabrication equipment such as a photolithography machine, an etching apparatus, and a thin film forming apparatus. Also, the laser beam machining apparatus of this embodiment can be applied to not only semiconductor wafers, but also fine electronic components and mechanical components.

The semiconductor apparatus is produced by subjecting a disk-like semiconductor wafer W, which is a substrate of the semiconductor apparatus, to various machining. The semiconductor wafer W is transferred between machining steps by accommodating a plurality of wafers W in a special accommodation case 1. In each of the machining steps, any one of the plurality of wafers W, which are accommodated in the accommodation case 1 with necessary distances, is taken out, and the wafer is processed. After processing, the wafer W is again accommodated in the accommodation case 1. A handling apparatus 2 mounted to a transfer arm of an articulated robot or the like operates the steps of taking out the wafer W from the accommodation case 1, accommodating the wafer W in the accommodation case 1, and mounting and setting the wafer W taken out from the accommodation case 1 on a predetermined position in the processing step.

According to the illustrated example, a transfer cabinet 3 is formed into a rectangular box shape whose vertical size is long. The accommodation case 1 and the handling apparatus 2 are disposed in the transfer cabinet 3. A laser beam machining apparatus 4 according to a preferred embodiment of the present invention used in the production step of the semiconductor wafer W is disposed adjacent to the transfer cabinet 3. The laser beam machining apparatus 4 forms a machining space 5a in a cabinet 5, which is formed into a rectangular box shape whose vertical size is long like the transfer cabinet 3.

Accommodated in the machining space 5a of the cabinet 5 are an alignment unit 6 for positioning and fixing the wafer W which is to be marked through an open and close mechanism (not shown) which intercepts a processing chamber in the cabinet 3 and the machining space 5a, and a machining processing unit 7 which forms, by a laser marker, a dot pattern on a front surface, a rear surface or a peripheral surface of the wafer W positioned by the alignment unit 6.

The alignment unit 6 is provided with a holding device or the like of the wafer W which is a machined object. The alignment unit 6 can controllably move the semiconductor wafer W in three axial directions (x, y, z) on an alignment stage 8 comprising three wafer clamping units 8a, . . . , 8a for supporting a rim of the wafer W at three points. Also, the alignment unit 6 can controllably rotate the semiconductor wafer W around a z-axis. The machining processing unit 7 gathers laser beam from a laser oscillator by an optical system which is a machining device such as a light introducing path, a lens and a spherical mirror, which are not shown. Then, the machining processing unit 7 marks dots in the marking area of the wafer W disposed on the alignment stage 8. While the machining processing unit such as a laser marker is used in this embodiment, the machining processing unit using etching or lithography may be used instead.

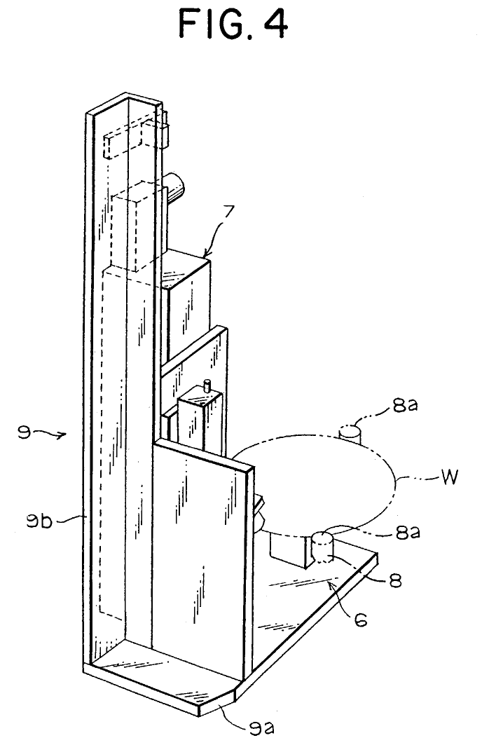

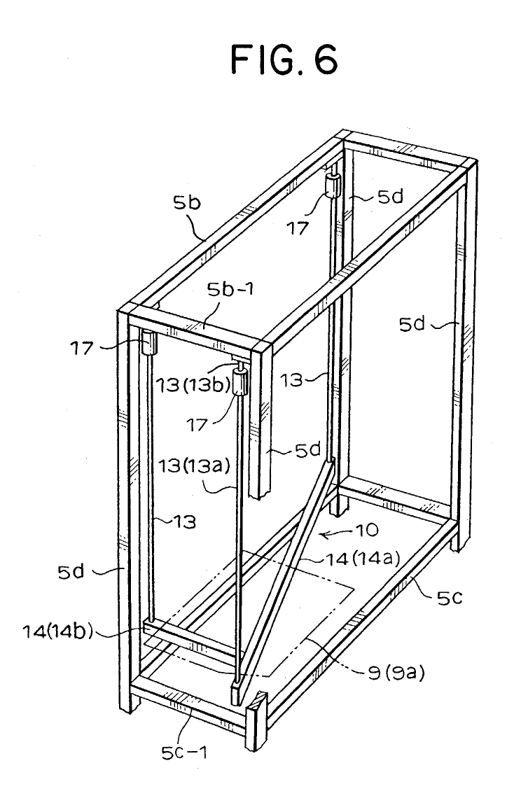

The main structures of the present invention are a vibration-isolating structure of the machining apparatus and its constituent members. In a first embodiment, in order to enhance rigidity of a device-supporting member 9 shown in FIG. 4 and to reduce generation of vibration in the vertical direction, the alignment unit 6 and the machining processing unit 7 are integrally fixed to and supported by the device-supporting member 9 extending in a vertical direction of the machining space 5a of the cabinet 5 in a multi-stage manner. This device-supporting member 9 has a sash-frame-like metal frame plate structure as shown in FIG. 4. Further, the device-supporting member 9 is set in the machining space 5a of the cabinet 5 by being hung by hanging means 10 shown in FIG. 6 so as to control horizontal vibration by utilizing high vibration attenuating characteristics of the hanging means 10.

FIG. 4 is a schematic view of an example of the device-supporting member 9. In this figure, the device-supporting member 9 consists of an L-shaped member comprising a board 9a extending in the horizontal direction and a frame-like vertical plate 9b having a combination of a plurality of flat plate members extending in the vertical direction on an upper surface of the board 9a. In the device-supporting member 9, in order to enhance its rigidity in the vertical direction, the alignment unit 6 is disposed on the board 9a which supports the entire device-supporting member 9, and the machining processing unit 7 is disposed on the vertical plate 9b. In the illustrated example, both the alignment unit 6 and the machining processing unit 7 are disposed on the device-supporting member 9 which is long in the vertical direction. With this structure, necessary vibration-isolating effect can be obtained with respect to a relatively low frequency component among frequency components generated by vibration in the vertical direction.

In the meantime, the shape, structure and material of the device-supporting member 9 are not limited to those in this embodiment. The shape, structure and material of the device-supporting member 9 may be selected to be suitable for shapes, structures and the like of the alignment unit 6 and the machining processing unit 7, for example. As the device-supporting member 9, members with such various shapes as an H-shape or a reversed T-shape may be employed instead of the L-shaped plate member. Also, as the material of the device-supporting member 9, such various materials as vibration-isolating alloy or vibration-isolating steel with great ability for absorbing vibration energy can be used.

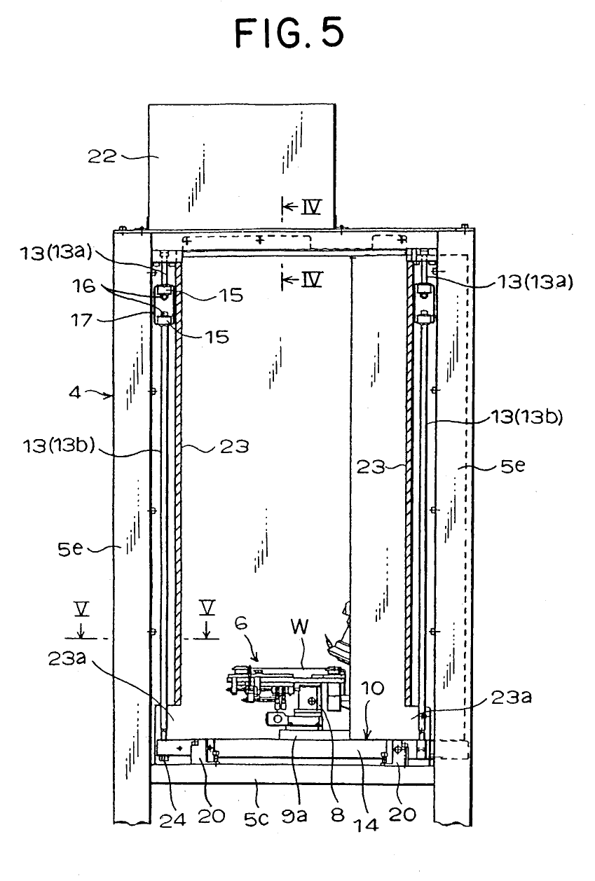

FIGS. 5 and 6 schematically show an example of the hanging means. In these figures, an upper frame 5b, an intermediate frame 5c and a lower frame (not shown) of the cabinet 5 are supported by four columns 5d, . . . , 5d respectively connected to and fixed to four corner portions. Outdoor-side panel plates 5e are mounted to the upper frame 5b, the intermediate frame 5c and the columns 5d, which define the machining space 5a of the cabinet 5, and air-tightly surround the machining space 5a. A contacting plate piece 12 with an L-shaped cross section for which a seal member 11 is provided is fastened and fixed by mounting bolts to each of the indoor-side corner edge portions of the upper frame 5b, the intermediate frame 5c and the columns 5d so as to bring an indoor-side edge portion of the panel plate 5e into air-tight contact with each of the indoor-side corner edge portions of the upper frame 5b, the intermediate frame 5c and the columns 5d.

Clean air supplied from a hepafilter 22 which eliminates fine dust and the like flows from a vent port (not shown) into the machining space 5a. The inflow clean air is directly discharged outward together with dust and the like from an exhaust duct (not shown) through the vent port (not shown), thereby keeping the inside of the machining space 5a clean. Meanwhile, the disposition of the seal member 11 is not limited to that of the illustrated example.

As shown in FIG. 6, two hanging members 13 and 13 are hung with a necessary distance from each other from a lower surface of a long upper frame 5b of two adjacent upper frames 5b, 5b-1 which are connected and fixed to each other at right angles. Meanwhile, one hanging member 13 is hung from a lower surface of the short upper frame 5b-1. These three hanging members 13, . . . , 13 have thin and long columnar shapes of the same length and are hung from three points triangularly in the machining space 5a. In the meantime, the hanging members 13 do not necessarily have a columnar shape, and may have an arbitrary shape such as a polygonal shape.

A long square-pole-like supporting rod 14 (14a) for placing the device-supporting member 9 is disposed above the intermediate frame 5c and on lower end portions of the hanging member 13 of the long upper frame 5b and the hanging member 13 of the short upper frame 5b-1, wherein said lower ends are disposed on a diagonal line of the upper frame 5b. Meanwhile, a short supporting rod 14 (14b) is provided on a lower end portion of the other hanging member 13 on the side of the long upper frame 5b so as to intersect with the long supporting rod 14a on the same horizontal plane. Among these two supporting rods 14, the short supporting rod 14b is fixed and supported in a cantilever manner, while the long supporting rod 14a are fixed and supported at both end portions thereof.

The supporting rod 14 is fastened and fixed by a nut 24 shown in FIG. 5 after a screw portion formed on the lower end portion of the hanging member 13 is fitted into an insertion hole formed in the supporting rod 14. Height of each of the hanging member 13 and the supporting rod 14 can be adjusted by the nut 24. The board 9a of the device-supporting member 9 is placed on an upper surface of the supporting rod 14. The supporting rod 14 and the board 9a of the device-supporting member 9 are mounted by appropriate fixing means such as bolts and welding (not shown).

Members with great vibration absorbing abilities such as rope springs and chains can be used as the hanging members 13. Vibration-isolating steel can be used as materials of the hanging members 13, as in the device-supporting member 9. In the meantime, arrangement and number of hanging members 13 and arrangement and fixing means of the supporting rods 14 are not limited to those of the illustrated example.

As shown in FIG. 5, the hanging member 13 of the illustrated example comprises two hanging members, namely, a first hanging member 13a and second hanging member 13b which vertically separate an upper portion of the hanging member 13. Rubber vibration isolators 15 which are vibration-absorbing members are inserted and fixed to opposing free end portions of the hanging members 13a and 13b. After the rubber vibration isolators 15 are inserted to the opposing free end portions of the hanging members 13a and 13b, nuts 16 are fastened and fixed to the screw portions formed at the free end portions, thereby mounting the rubber vibration isolators 15 to the hanging members 13a and 13b.

The pair of upper and lower rubber vibration isolators 15 and 15 according to the illustrated example are accommodated in a metal case body 17, which is for supporting the vibration-absorbing members, at a necessary distance from each other. An upper inner wall surface of the case body 17 is hung and supported through the rubber vibration isolator 15 of the upper first hanging member 13a. Whereas, the lower second hanging member 13b is hung and supported at a lower inner wall surface of the case body 17 through the rubber vibration isolator 15. The rubber vibration isolators 15, 15 of the first and second hanging members 13a and 13b are disposed at a necessary distance from each other in a state in which the isolators are pushed against the upper inner wall surface and the lower inner wall surface of the case body 17. The hanging members 13a and 13b are hung with necessary elasticity of the rubber vibration isolators 15 and 15.

This structure enhances attenuation effect of vibration in the vertical direction with relatively high frequency component among frequency components generated by vertical vibration. Accordingly, vertical vibration of about 10 Hz or more transmitted to the alignment unit 6 in the machining space 5a of the cabinet 5 and to the above-described devices of the machining processing unit 7 can be absorbed. As a result, extremely fine optical machining can be carried out precisely.

Moreover, the alignment unit 6 and the machining processing unit 7 are fixed and supported by the device-supporting member 9 integrally, and the device-supporting member 9 is hung down. Therefore, with respect to the vibration of about 10 Hz or less, rigidity of the device-supporting member 9 is enhanced, vertical vibration is reduced, and horizontal vibration is absorbed. Therefore, extremely fine optical machining is not hindered. In the meantime, the case body 17 is not limited to that in the illustrated example, and a rubber vibration isolator supporting member having arbitrary shape, structure and the like capable of supporting the pair of the upper and lower rubber vibration isolators 15, 15 in their separated state.

The compressive state of the rubber vibration isolator 15 can be adjusted by loosing the fastening state of the nut 24 shown in FIG. 5 which fastens and fixes the hanging member 13 and the supporting rod 14. If the rubber vibration isolator 15 is worn by long term use, the elasticity of the rubber vibration isolator 15 can be adjusted by fastening the nut 24. Although rubber material is employed as the vibration-isolating member in this embodiment, the present invention is not limited to this: For example, elastic material such as resin with great vibration absorption ability can be used. Also, material, thickness, size, form, position and disposed number of the vibration-absorbing members can be appropriately selected in order to obtain necessary vibration attenuation ability.

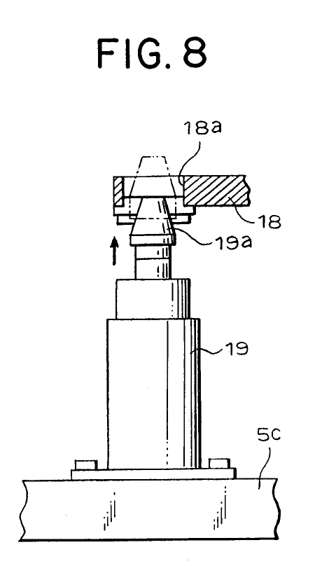

Further, a holding plate member 18 is fixed to one side portion in the longitudinal direction of the board 9a of the device-supporting member 9 of the illustrated example. As shown in FIG. 3, the holding plate member 18 is of substantially U-shape as viewed from above. As shown in FIG. 8, an air cylinder 19 is provided on an upper surface of the intermediate frame 5c of the cabinet 5, at a position corresponding to a bifurcated portion of the holding plate member 18. A fitting hole 18a through which a conical fixing pin 19a fixed to a rod end of the air cylinder 19 is inserted and supported is formed in the bifurcated portion of the holding plate member 18. The holding plate member 18 and the air cylinder 19 constitute position-fixing means for positioning and fixing the device-supporting member 9 in the machining space 5a of the cabinet 5.

The position-fixing means described above enables to fix the device-supporting member 9 to a predetermined position and to hold the alignment stage 8 in its stationary state when the wafer W taken out from the accommodation case 1 by operation of the handling apparatus 2 mounted to an arm of the articulated robot is placed and set on the alignment stage 8 disposed on the board 9a of the device-supporting member 9. Accordingly, it is possible to precisely and swiftly position and fix the wafer W.

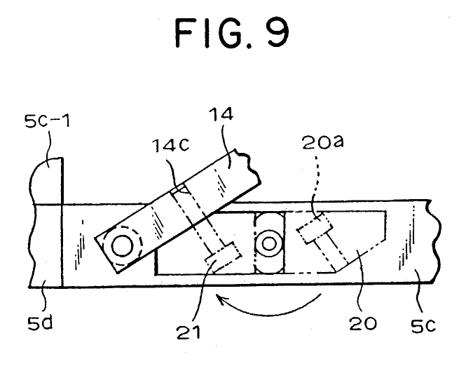

Furthermore, as shown in FIG. 9, a fixing member 20 for fixing the supporting rod is disposed on an upper surface of the intermediate frame 5c of the cabinet 5, in the vicinity of a portion corresponding to the supporting rod 14 fixed to the lower end portion of the hanging member 13. The fixing member 20 is mounted to the upper surface of the intermediate frame 5c such that the fixing member 20 can rotate horizontally around the mounting bolt. A bolt insertion hole 20a is provided in the fixing member 20 at a position corresponding to a bolt mounting hole 14c having an inner screw formed in the supporting rod 14.

In order to fix the supporting rod 14, the supporting rod 14 is first rotated horizontally around its mounting bolt along the upper surface of the intermediate frame 5c, and the bolt mounting hole 14c of the supporting rod 14 and the bolt insertion hole 20a of the fixing member 20 are brought into alignment with each other. Then, a fixing bolt 21 is screwed into and engaged with the bolt mounting hole 14c through the bolt insertion hole 20a, and the supporting rod 14 is fixed to the fixing member 20.

Also in this embodiment, the fixing member 20 has a role for positioning and fixing the device-supporting member 9 in the machining space 5a of the cabinet 5. It is possible to position and fix the device-supporting member 9 at a predetermined position by the simple position-fixing means for fastening and fixing by the fixing bolt 21. Therefore, as in such position-fixing means as the holding plate member 18 and the air cylinder 19, it is possible to set the device-supporting member 9 in the machining space 5a of the cabinet 5 in its stationary state. Accordingly, it is possible to stably and freely transfer the various devices mounted in the device-supporting member 9 upon transferring the machining apparatus 4.

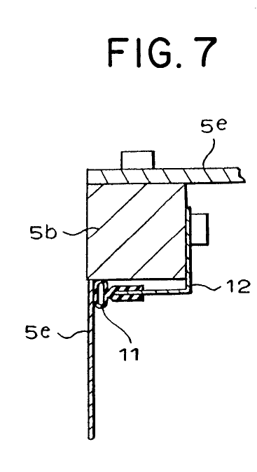

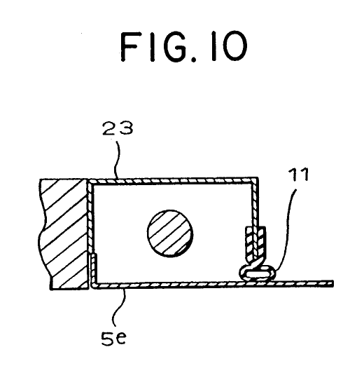

Adherence of even slight dust or fine particles to and damage on the wafer surface should be avoided in processing of the semiconductor wafer W. Therefore, the air-tightness of the machining space 5a of the cabinet 5 is maintained with the seal member 11 as described above and as shown in FIG. 7. A cover body 23 with substantially U-shaped cross section for preventing entrance of outside air is provided at an peripheral portion of the hanging member 13 of the device-supporting member 9 as shown in FIG. 10. The seal member 11 made of rubber or the like is provided for an edge portion of the cover body 23 at a side of the panel plate 5e such that the cover body 23 air-tightly contacts with the panel plate 5e.

Further, as shown in FIG. 5, an opening 23a, which opens downward at a position lower than the wafer W disposed on the alignment stage 8, is provided at a lower end of the cover body 23. Dust and the like discharged from the opening 23a are directly discharged outward from the exhaust duct (not shown) through the vent port (not shown) together with clean air supplied from the hepafilter 22. Therefore, it becomes possible to prevent defects of the wafer W resulting from adherence of dust generated upon vibration isolation by the hanging means 10, and generation of dust by such vibration-isolating apparatus as the hanging means 10 can be avoided.

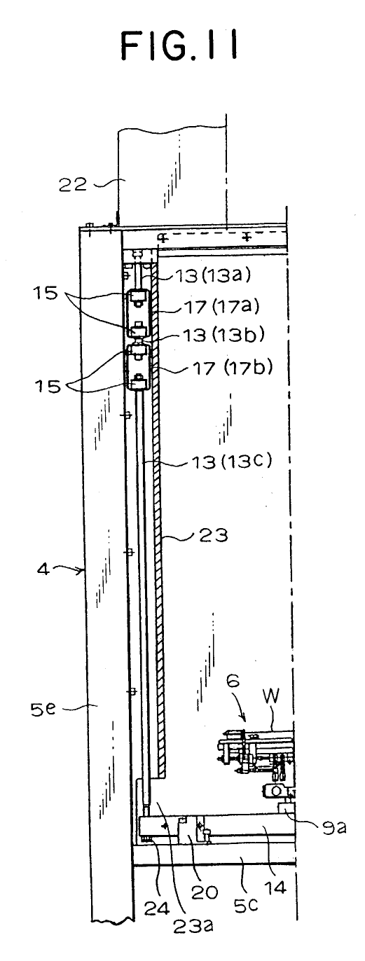

FIG. 11 is an enlarged view of a portion of the apparatus viewed from the arrow III in FIG. 2, and schematically shows a second embodiment of the hanging member 13. In the first embodiment described above, one vibration-isolating structure is disposed in the hanging member 13. Whereas, in the second embodiment, two adjacent vibration-isolating structures are disposed in the hanging member 13. In FIG. 11, members substantially the same as those in the first embodiment are designated with the same names and reference numerals. Therefore, detailed explanation of such members will be omitted.

In FIG. 11, rubber vibration isolators 15 are respectively fitted and fixed to opposing free end portions of vertically separated three hanging members, namely, first, second and third hanging members 13a, 13b, 13c. The second hanging member 13b is set to be shorter than other hanging members 13a, 13c, while the third hanging member 13c is set to be longer than the other hanging members 13a and 13b. A pair of rubber vibration isolators 15 of the first hanging member 13a and the second hanging member 13b are accommodated in a first case body 17 (17a). Whereas, a pair of rubber vibration isolators 15 of the second hanging member 13b and the third hanging member 13c are accommodated in a second case body 17 (17b) adjacent to the first case body 17 (17a).

An upper inner wall surface of the first case body 17a is hung down and supported through the rubber vibration isolator 15 of the first hanging member 13a, while the second hanging member 13b is hung down and supported from a lower inner wall surface of the first case body 17a through the rubber vibration isolator 15. Further, an upper inner wall surface of the second case body 17b is hung down and supported through the rubber vibration isolator 15 of the second hanging member 13b, while the third hanging member 13c is hung down and supported from a lower inner wall surface of the second case body 17b through the rubber vibration isolator 15. Each of the hanging members 13a-13c is hung down with proper elasticity of each of the rubber vibration isolators 15. In this second embodiment, the vibration-isolating structures are adjacently arranged at two portions of the hanging member 13. Yet, the present invention is not limited to this.

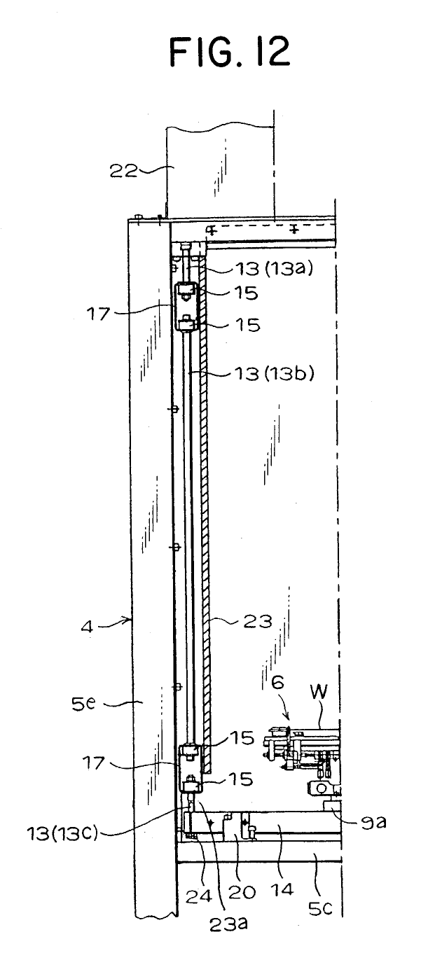

FIG. 12 is a schematic view of a third embodiment of the hanging member 13. FIG. 12 is an enlarged view of a portion of the apparatus viewed from the arrow III in FIG. 2. In FIG. 12, members substantially the same as those in the first and second embodiments are designated with the same names and reference numerals.

In FIG. 12, case bodies 17 for supporting vibration-absorbing members are mounted to upper and lower portions of the hanging member 13 comprising three hanging members, namely, first to third hanging members 13a, 13b, 13c. The third hanging member 13c is set to be shorter than the other hanging members 13a, 13b. Whereas, the second hanging member 13b is set to be longer than the other hanging members 13a, 13c. Structures of the third embodiment other than this feature are the same as those of the embodiments described above. Each of the hanging member 13 is hung down and supported in a state that rubber vibration isolators 15 separated from each other are pushed against upper inner wall surfaces and lower inner wall surfaces of the case bodies 17. In this manner, the position and the disposed number of the hanging means 10 of the present invention can be set arbitrarily, and high flexibility in design can be obtained.

As apparent from the above explanation, the laser beam machining apparatus 4 according to this embodiment suppresses horizontal vibration by utilizing high vibration attenuation characteristics of the hanging means 10. Moreover, devices of the alignment unit 6 and the machining processing unit 7 are fixed to and supported by the device-supporting member 9 integrally, thereby enhancing rigidity of the device-supporting member 9 and reducing generation of vertical vibration. Therefore, it becomes possible to absorb the vibration transmitted to devices by the alignment unit 6 and the machining processing unit 7 with a simple structure in which the hanging means 10 is disposed on a side portion of the device-supporting member 9 in the machining space 5a of the cabinet 5. Furthermore, the extremely fine optical machining can be carried out.

In addition, the flexibility of design of the device-supporting member 9 is enhanced because the hanging means 10 can effectively use the small space around the device-supporting member 9. Moreover, the laser beam machining apparatus 4 can be made compact because the structure of the hanging means 10 can be simplified and thus the hanging means 10 can be assembled in the limited space in the machining space 5a. In the meantime, the present invention is not limited to the above embodiments, and the invention naturally includes technical range which can easily be modified from these embodiments by a person skilled in the art.

What is claimed is:

1. A machining apparatus comprising:
a device-supporting member which is disposed in a machining space of a machining apparatus body and is for integrally fixing and supporting devices such as a machining device and a workpiece-holding device; and
hanging means for hanging down the device-supporting member in said machining space.

2. A machining apparatus according to claim 1, wherein said hanging means has a vibration-absorbing member.

3. A machining apparatus according to claim 1, wherein said device-supporting member extends in the vertical direction of said machining space, and said devices are disposed in said device-supporting member in its vertical direction.

4. A machining apparatus according to claim 2, wherein said device-supporting member extends in the vertical direction of said machining space, and said devices are disposed in said device-supporting member in its vertical direction.

5. A machining apparatus according to claim 1 or 2, further comprising position-fixing means for positioning and fixing said device- supporting member in said machining apparatus body.

6. A machining apparatus according to claim 1 or 2, further comprising a cover body for surrounding a peripheral portion of said hanging means.

7. A machining apparatus according to any one of claims 1 to 4, wherein said machining apparatus is a laser beam machining apparatus.
